(19) United States
(12) Patent Application Publication
(10) Pub. No.: US 2026/0357648 A1
(43) Pub. Date: Nov. 12, 2026

(54) Safety Gate with a Pet Door

(71) Applicant: Shenzhen Xinyuyou Technology Co., Ltd, Shenzhen (CN)

(72) Inventor: Yongge Zheng, Shenzhen (CN)

(21) Appl. No.: 19/238,211

(22) Filed: Jun. 13, 2025

(30) Foreign Application Priority Data
May 12, 2025 (CN) 2025209223507

(51) Int. Cl. E06B 7/32; E06B 9/04; E06B 9/00

(52) U.S. Cl. CPC E06B 7/32; E06B 9/04; E06B 2009/002

(57) ABSTRACT

A safety gate with a pet door includes a frame, a first gate and a second gate. The first gate is arranged on the frame. One end of the first gate can be switched between two states of being attached to the frame or being detached from the frame, and the other end is movably connected to the frame; a locking component is arranged on the first gate and a channel is arranged on one side of the locking component. The second gate is arranged in the channel and is provided with a plurality of first slots. The locking component can be clamped into different slots of the second gate. The safety gate allows pets to pass along the second gate (pet door) while preventing children from crossing the safety gate, to confine children in a safe area to ensure their safety.

### CROSS-REFERENCE TO RELATED APPLICATIONS

The present application claims the benefit of Chinese Patent Application No. 2025209223507 filed on May 12, 2025, the contents of which are hereby incorporated by reference.

### TECHNICAL FIELD

The present invention belongs to the technical field of gates and particularly relates to a safety gate with a pet door.

### TECHNICAL BACKGROUND

Safety gates play an important role in aisle safety protection, such as stair entrances, corridors and other scenes. They can effectively prevent children from entering dangerous areas by mistake or limit the range of activities of pets.

However, existing safety gates still have defects in the management of passage of human and pet. When only pets need to pass freely, users need to repeatedly unlock, open, close and lock the main door, and the operation process is cumbersome and time-consuming.

### INVENTION CONTENT

In order to overcome the deficiencies of the prior art, the present invention provides a safety gate with a second gate, which can be opened and closed independently. When the second gate is opened, the safety gate can remain closed, allowing pets to pass through the second gate while preventing children from crossing the safety gate, so as to confine children in a safe area to ensure their safety.

The technical scheme adopted by the present invention for solving the technical problems is as follows:

A safety gate with a pet door includes a frame, a first gate and a second gate. The first gate is arranged on the frame. One end of the first gate can be switched between two states of being attached to the frame or being detached from the frame, and other end is movably connected to the frame; a locking component is arranged on the first gate and a channel is arranged on one side of the locking component. The second gate is arranged in the channel and is provided with a plurality of first slots, and the locking component can be clamped into one of the first slots.

Further, the first gate includes a plurality of first connection pipes, two second connection pipes, a first beam and a second beam. The plurality of first connection pipes and the two second connection pipes are distributed along a lateral direction of the first gate. Two ends of the plurality of first connection pipes are respectively connected to the first beam and the second beam. One end of the two second connection pipes is connected to the first beam, and the locking component is clamped to another end of the second connection pipe away from the first beam; the locking component is fixedly connected to two adjacent of the plurality of first connection pipes.

Further, the second gate includes two movable rods. A second slot is respectively arranged at the other end of each of the two second connection pipes away from the first beam. The two movable rods are provided with the plurality of first slots that are evenly distributed. The locking component is symmetrically configured to include two locking blocks; the two locking blocks horizontally shift toward each other.

Further, the locking component includes two buttons, a first spring and two active blocks. The two locking blocks are respectively arranged on one side of the two active blocks. The first spring is arranged between another side of the two active blocks. The two active blocks are respectively provided with a guiding groove. Each of the two buttons are respectively provided with two guiding convex blocks; each of the two guiding convex blocks is adapted to the guiding groove.

Further, a second spring is respectively arranged on one side of the two buttons facing the two active blocks, and the second spring provides an elastic restoring force for the two buttons.

Further, the locking component also includes a cover. The cover is fixedly connected to the first connection pipe. The pressing part of the two buttons expose on the surface of the cover. The two guiding convex blocks of each of the two buttons extends into the interior of the cover. The second spring is arranged between the pressing part of the button and the cover.

Further, the cover is provided with a plurality of locking ports. The two buttons are respectively provided with a plurality of locking members. The plurality of locking members cooperate with the plurality of locking ports to restrict the button in the cover.

Further, the second gate also includes a sliding plate. The bottom end of the two movable rods extends into the sliding plate and is fixedly connected to the sliding plate. Two ends of the sliding plate are respectively provided with a through hole for the two djacent of the plurality of first connection pipes to pass through.

Further, two pressure bolts are respectively arranged on the left side and right side of the frame.

Further, an end of the first gate that can be attached to the frame is set as the first end, and the other end of the first gate that can be movably connected to the frame is set as the second end. A switch is set on the top side of the first end of the first gate, and the first gate can be attached to the frame or detached from the frame by the switch. A rotating shaft is arranged at the second end of the first gate, and the frame is provided with a rotating hole adapted to the rotating shaft.

The beneficial effects of the present invention:

The present invention provides a safety gate with a pet door. The second gate can be opened and closed independently. And when the second gate is opened, the safety gate can be kept in a closed state, so that the pet is allowed to pass through the second gate while children are prevented from crossing the safety gate, so as to restrict the children in a safe area to ensure their safety.

### DESCRIPTION OF FIGURES

FIG. 1 is a schematic view of a safety gate of the present invention;

FIG. 2 is a cross-sectional view along the line A-A in FIG. 1;

FIG. 3 is an enlarged schematic view of point A in FIG. 2;

FIG. 4 is a schematic view of the safety gate of the present invention from another angle;

FIG. 5 is a cross-sectional view along the line B-B in FIG. 4;

FIG. 6 is an enlarged schematic view of point B in FIG. 5;

FIG. 7 is a schematic view of another state of the safety gate of the present invention;

FIG. 8 is a schematic view of a locking component in a safety gate of the present invention;

FIG. 9 is an exploded view of the locking component of the safety gate of the present invention;

FIG. 10 is a schematic view of the cover of the safety gate of the present invention;

FIG. 11 is a schematic view of the first gate of the safety gate of the present invention;

### DESCRIPTION OF MARKS IN FIGURES

1- frame; 11- pressure bolt; 12- lock; 13- rotating hole;

2- first gate; 21- first connection pipe; 22- second connection pipe; 221- second slot; 23- first beam; 24- second beam; 25- switch; 26- rotating shaft;

3- second gate; 31- moveable rod; 311- first slot; 32- sliding plate;

4- locking component; 41- locking block; 42- button; 421- guiding convex block; 422- locking member; 43- first spring; 44- second spring; 45- active block; 451- guiding groove; 46- cover; 47- locking port; 471- inserting hole; 48- first through hole; 481- second through hole.

### DETAILED DESCRIPTION OF THE EMBODIMENTS

The present embodiment only shows an explanation of the present invention and it is not a limitation to the present invention. The skilled in the art can make modifications to this embodiment as needed without making any creative contributions after reading this specification, which are always protected by the patent law as long as they are within the scope of the claims of the present invention.

It should be noted that when an element is called as being “fixed to” or “arranged on” another element, it can be directly on the other element or indirectly on the other element. When an element is called as being “connected to” another element, it can be directly connected to the other element or indirectly connected to the other element.

It should be noticed that the terms “length”, “width”, “above”, “below”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present invention and simplifying the description, rather than indicating or implying that the device or component must have a specific orientation, construct and operate in a specific orientation, therefore, it cannot be understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “a plurality of” means two or more, unless otherwise specifically defined.

The present invention provides a safety gate with a pet door. The second gate can be opened and closed independently. And when the second gate is opened, the safety gate can be kept in a closed state, allowing the pet to pass through the second gate while preventing children from crossing the safety gate, so as to confine the children in a safe area to ensure their safety.

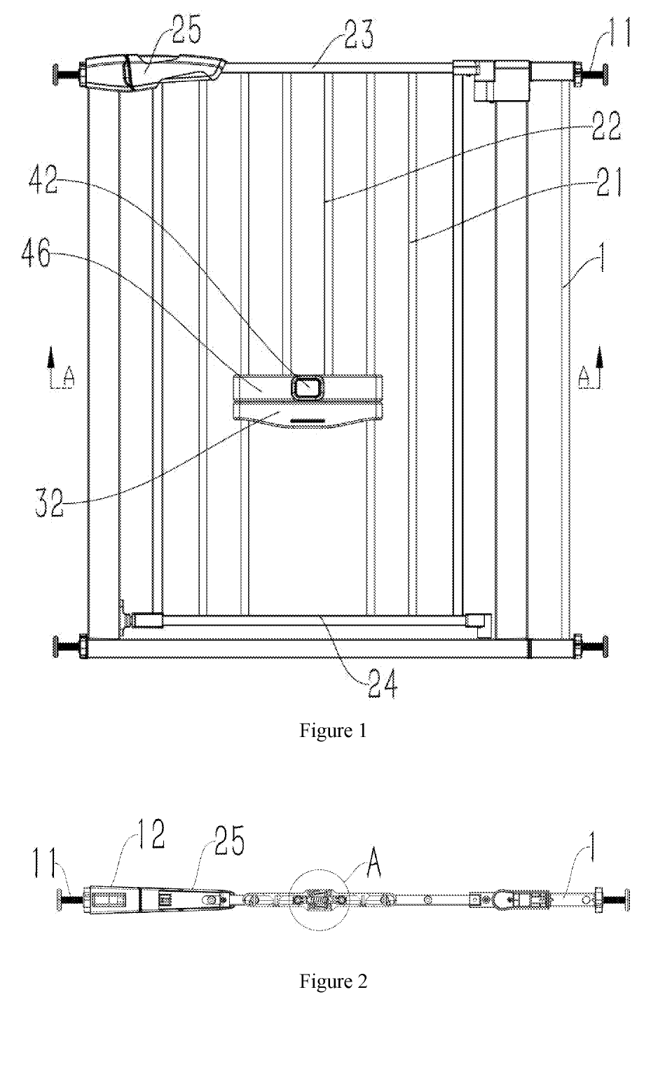

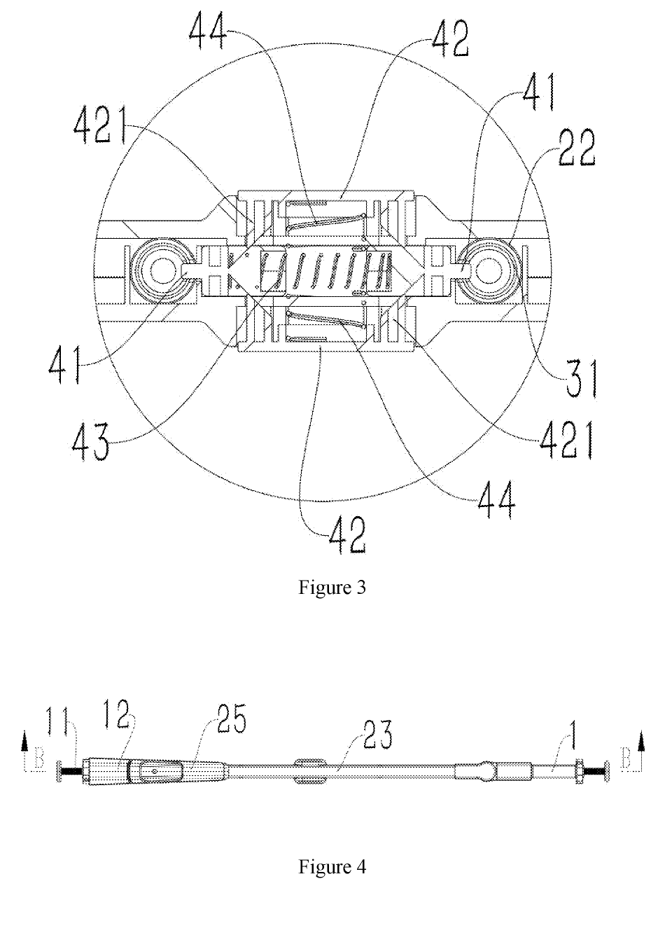

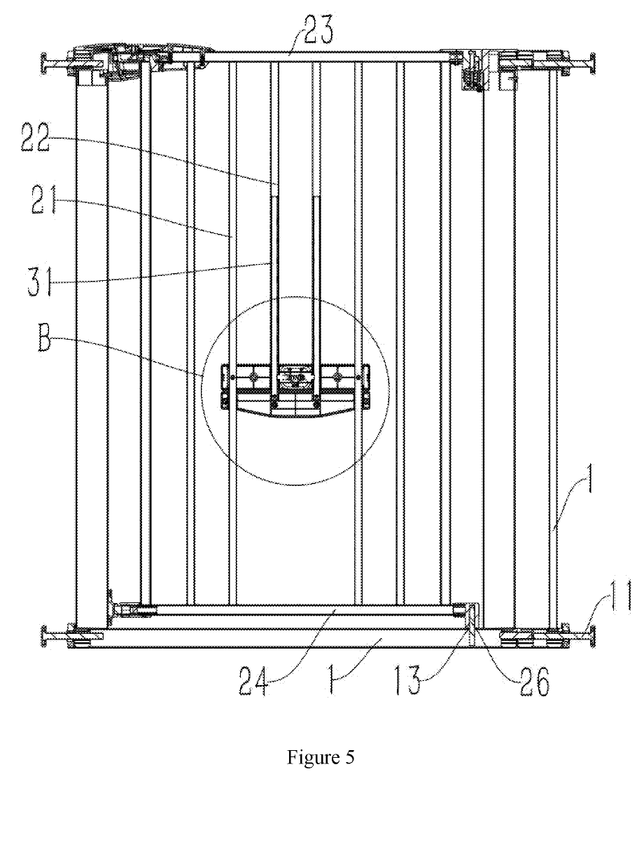

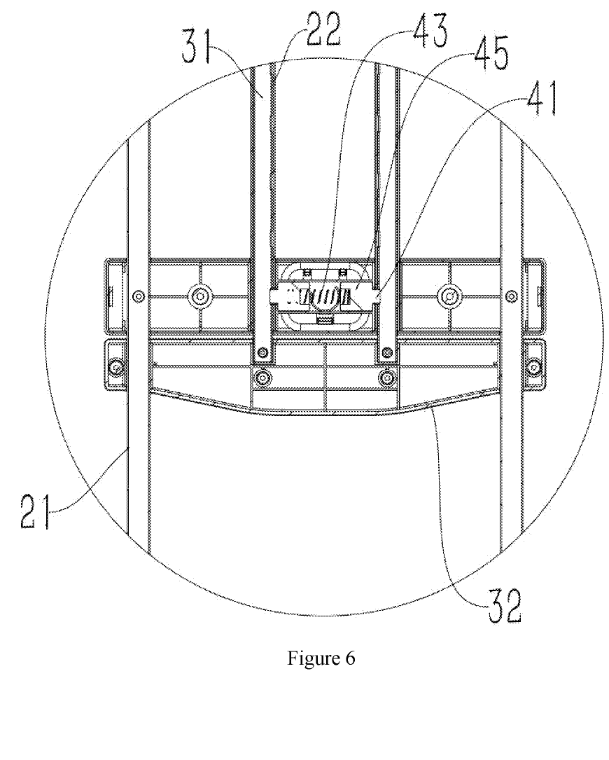

Referring to FIGS. 1 - 10, the present embodiment provides a safety gate with a pet door, including a frame 1, a first gate 2 and a second gate 3. The first gate 2 is arranged on the frame 1. One end of the first gate 2 can be switched between two states of being attached to the frame 1 or being detached from the frame 1, and the other end of the first gate 2 is movably connected to the frame 1; a locking component 4 is arranged on the first gate 2, and a channel is arranged on one side of the locking component 4. The second gate 3 is arranged in the channel; and the second gate 3 is provided with a plurality of first slots 311. The locking component 4 can be clamped into to any two of the plurality of first slots 311.

Preferably, the first gate 2 includes a plurality of first connection pipes 21, two second connection pipes 22, a first beam 23 and a second beam 24. The two ends of the plurality of first connection pipes 21 are respectively connected to the first beam 23 and the second beam 24. One end of the two second connection pipes 22 is repectively connected to the first beam 23, and the locking component 4 is clamped to an other end of the two second connection pipes 22 away from the first beam 23; two ends of the locking component 4 is fixedly connected to the two adjacent of the plurality of first connection pipes 21.

In this embodiment, the two second connection pipes 22 are arranged at a middle of the first gate 2. The plurality of first connection pipes 21 are arranged on two sides of the two second connection pipes 22. In practical applications, the two second connection pipe 22 can also be arranged at a corner of the first gate 2.

As can be seen from the accompanying drawings, the locking component 4, the second beam 24 and the two adjacent of the plurality of first connection pipes 21 together enclose a space, which is the channel allowing pets to go through.

Further, the second gate 3 includes two movable rods 31. A second slot 221 is respectively arranged at the other end of the two second connection pipes 22 away from the first beam 23. The two movable rods 31 are respectively provided with a plurality of first slots 311 that are evenly distributed. The locking component 4 is symmetrically configured to include two locking blocks 41; the two locking blocks horizontally shift toward each other. When the two movable rods 31 are inserted into the two second connection pipes 22 one by one, and any two of the plurality of first slots 311 are respectively aligned with the second slot 221, then the two locking blocks 41 can be moved and inserted into the any two of the plurality of first slots 311 and the second slot 221 at the same time.

Understandably, the locking component 4 and the two second connection pipes 22 are in a relatively fixed state, and the two movable rods 31 can move in the vertical direction. In actual applications, the user can adjust the two movable rods 31 to a preset height according to actual needs, so as to make two of the plurality of first slots 311 at different positions are aligned with the second slot 221 on the two second connection pipes 22. And then the two locking blocks 41 of the locking component 4 are clamped into the two of the plurality of first slots 311 and the second slot 221, so that the movable rod 31 can be kept at the preset height and cannot move.

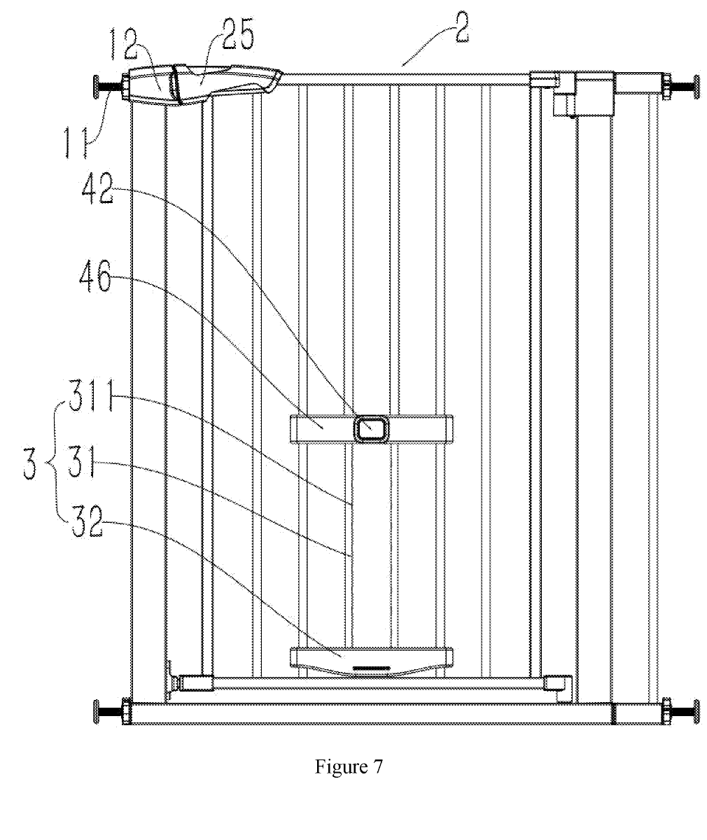

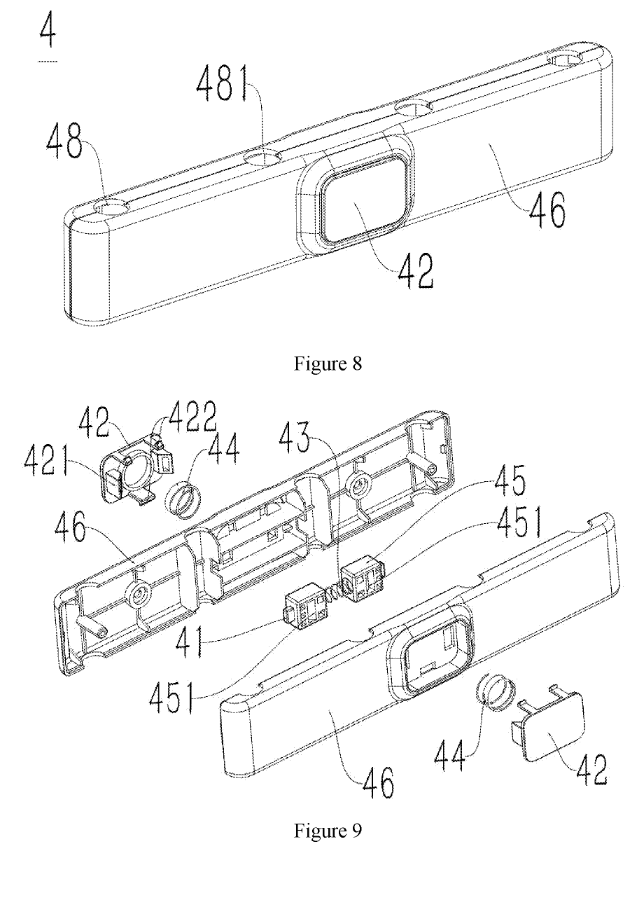

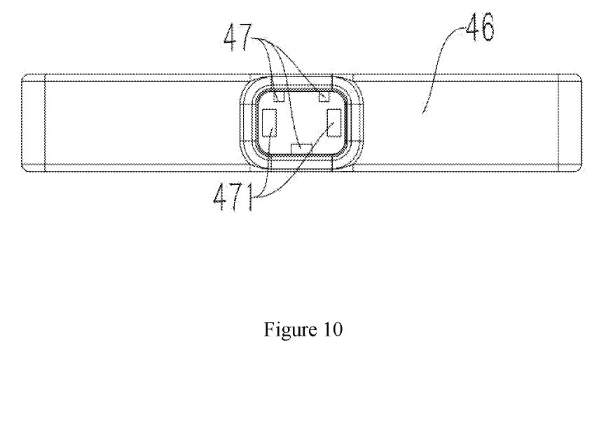

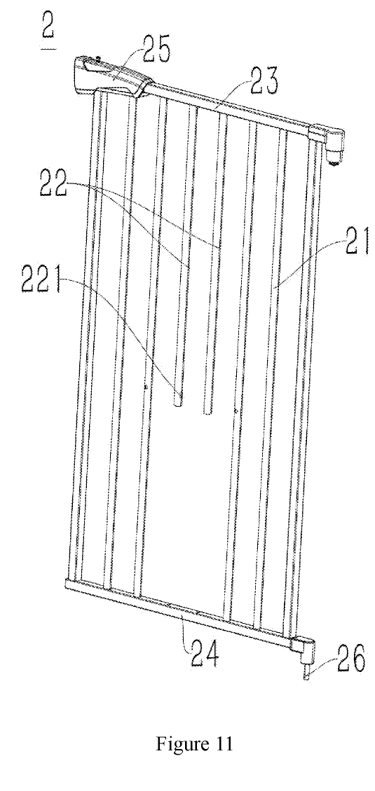

FIGS. 1 and 7 are schematic views of two states of the safety gate in this embodiment. If the user wants a larger passage to allow a larger pet to pass through, he/she just needs to pull the two movable rods 31 upward and clamped into the two locking blocks 41; if the user wants to reduce the size of the passage to allow a smaller pet to pass through, he/she then needs to pull the two movable rods 31 downward to a preset position and then clamped into the two locking blocks 41. In both cases, the passage is enclosed by the lower end of the two movable rod 31, the two adjacent of the plurality of first connection pipes 21, and the second beam 24. If the user wants to close the passage and prevent the pet from passing through, he/she can pull the two movable rods 31 downward until the two movable rods 31 abut against the second beam 24 and then clamped into the two locking blocks 41.

Preferably, the locking component 4 includes two button 42, a first spring 43 and two active blocks 45. The two locking block 41 are respectively arranged on one side of the two active blocks 45, the first spring 43 is arranged between the other side of the two active blocks 45. The two active blocks 45 are respectively provided with a guiding groove 451, and two ends of each of the two buttons 42 are respectively provided with a guiding convex block 421.

Further, a second spring 44 is respectively arranged on one side of the two buttons 42 facing the two active blocks 45, and the second spring 44 provides an elastic restoring force for the two buttons 42.

Understandably, when an external force is applied to make the two guiding convex blocks 421 slide along the guiding groove 451 of the two active blocks 45, the two active blocks 45 will move along the direction of the first spring 43, in other words, the two locking blocks horizontally shift toward each other and get closed with each other. At the same time, the two locking blocks 41 will disengage from two of the plurality of first slots 311 and the second slot 221, and the two movable rods 31 are in a movable state; when no external force is applied, the elastic restoring force of the first spring 43 will push the two active blocks 45 to move back to the initial position. At the same time, the two locking blocks 41 will be clamped into another two of the plurality of first slots 311 and the second slot 221 to limit the movement of the two movable rods 31.

Further, the locking component also includes a cover 46. The cover 46 is fixedly connected to the two adjacent of the plurality of first connection pipes 21. The pressing part of the two buttons 42 respectively expose on the surface of the cover 46. The two guiding convex blocks 421 of each of the two buttons 42 extend into the interior of the cover 46. The second spring 44 is respectively arranged between the pressing part of the two buttons 42 and the cover 46.

Further, the cover 46 is provided with a plurality of locking ports 47. The two buttons 42 are respectively provided with a plurality of locking members 422. The plurality of locking members 422 cooperate with the plurality of locking ports 47 to restrict the button 42 in the cover 46, so as to prevent the two buttons 42 from falling off the cover 46.

An inserting hole 471 is arranged on two surfaces of the cover 46; the two guiding convex blocks 421 pass through the inserting hole 471 and insert into the interior of the cover 46 along the inserting hole 471; and each of the two guiding convex blocks 421 overlaps in the guiding groove 451. When the user applies the external force to one of the two buttons 42, the two guiding convex blocks 421 generates a pushing force on the guiding groove 451 of the two active blocks 45, driving the two locking blocks 41 to disengage from the two of the plurality of first slots 311 and the second slot 221 of the two second connection pipes 22.

In this embodiment, the cover 46 is further provided with two first through holes 48 and two second through holes 481 at intervals. The two adjacent of the plurality of first connection pipes 21 respectively penetrate the cover 46 along the two first through holes 48 so as to reach a fixed connection with the cover 46. The two second connection pipes 22 respectively insert into the cover 46 along the two second through holes 481 so as to clamp into the two locking blocks 41 respectively. Preferably, the second gate further includes a sliding plate 32. The bottom end of the two movable rods 31 extends into the sliding plate 32 so as to be fixedly connected with the sliding plate 32. Two ends of the sliding plate 32 are respectively provided with a through hole for the two adjacent of the plurality of first connection pipes 21 to pass through.

Understandably, the two adjacent of the plurality of first connection pipes 21 respectively pass through the through hole on the two ends of the sliding plate 32. The two adjacent of the plurality of first connection pipes 21 provide a guide for the movement of the sliding plate 32 to ensure that the two movable rods 31 move along the vertical direction to avoid deviation during the movement, resulting in the two locking blocks 41 unable to clamp into the any two of the plurality of first slots 311.

In this embodiment, the sliding plate 32 can protect the end of the two movable rods 31 from directly colliding with the pet, so as to extend the service life of the two movable rods 31; and the outer periphery of the sliding plate 32 is rounded to protect the pet from injury when walking along the passage.

Preferably, two pressure bolts 11 are respectively arranged on the left side and right side of the frame 1. When installing the safety gate provided in this embodiment, the two pressure bolts 11 can be rotated to adjust the tightness between the frame 1 and the walls on two sides, so as to achieve a stable installation of the gate.

Further, the end of the first gate 2 that can be attached to the frame 1 is set as the first end, and the other end of the first gate 2 that can be movably connected to the frame 1 is set as the second end. A switch 25 is arranged on the top side of the first end of the first gate 2. The first gate 2 can be attached to the frame 1 or detached from the frame 1 by pressing the switch 25. A rotating shaft 26 is arranged at the second end of the first gate 2, and the frame 1 is provided with a rotating hole 13; the rotating hole 13 is adapted to the rotating shaft 26. The frame 1 is provided with a lock 12 adapted to the switch 25, and the lock tongue of the lock 12 can be inserted into or detached from the lock 12 by pressing the switch 25.

It should be noted that any types of the switch 25 capable of realizing an opening or locking function can be applied to the safety gate provided in this embodiment, and the switch 25 will not be described in detail herein.

It is understandable that those skilled in the art can combine various implementations in the above embodiments under the guidance of the above embodiments to obtain technical solutions of multiple implementations.

The above description is only a preferred embodiment of the present invention and is not intended to limit the present invention. Any modifications, equivalent replacements and improvements made within the spirit and principles of the present invention shall be included in the protection scope of the present invention.

1. A safety gate with a pet door, which comprises a frame, a first gate and a second gate, wherein the first gate is arranged on the frame; one end of the first gate can be switched between two states of being attached to the frame or being detached from the frame; another end of the first gate is movably connected to the frame; a locking component is arranged on the first gate; a channel is arranged on one side of the locking component; the second gate is arranged in the channel; the second gate is provided with a plurality of first slots; two sides of the locking component are respectively clamped into any two of the plurality of first slots that are arranged on a same horizontal line of the second gate; the second gate comprises two moveable rods; each of the two moveable rods is provided with the plurality of first slots; the plurality of first slots are evenly distributed; the locking component is symmetrically configured to comprise two locking blocks, two buttons, a first spring and two active blocks; the two locking blocks horizontally shift toward each other; each of the two locking blocks is respectively arranged on one side of each of the two active blocks; two ends of the first spring are respectively connected with an other side of each of the two active blocks; the two active blocks are respectively provided with a guiding groove; each of the two buttons is respectively provided with two guiding convex blocks; each of the two guiding convex blocks is adapted to the guiding groove; a second spring is arranged on one side of each of the two buttons facing the two active blocks; the second spring provides an elastic restoring force for the each of the two buttons; the second gate further comprises a sliding plate; a bottom end of each of the two moveable rods extends into the sliding plate and is fixedly connected to the sliding plate.

2. The safety gate with a pet door according to claim 1, wherein the first gate comprises a plurality of first connection pipes, two second connection pipes, a first beam and a second beam; the plurality of first connection pipes and the two second connection pipes are distributed along a lateral direction of the first gate; two ends of the plurality of first connection pipes are respectively connected to the first beam and the second beam; one end of each of the two second connection pipes is connected to the first beam; the locking component is clamped to another end of the two second connection pipes away from the first beam; the locking component is fixedly connected to two adjacent of the plurality of first connection pipes.

3. The safety gate with a pet door according to claim 2, wherein a second slot is respectively arranged at the one end of the each of the two second connection pipes away from the first beam; when the two movable rods insert into the two second connection pipes one by one till the any two of the plurality first slots are respectively aligned with the second slot of each of the at least two second connection pipes, the locking block moves and inserts into the any two of the plurality of first slots and the second slot at a same time.

4. (canceled)

5. (canceled)

6. The safety gate with a pet door according to claim 2, wherein the locking component further comprises a cover; the cover is fixedly connected to the two adjacent of the plurality of first connection pipes; a pressing part of the each of the two buttons is exposed on a surface of the cover; the guiding convex block of the each of the two buttons extends to an interior of the cover; the second spring is arranged between the pressing part of the each of the two buttons and the cover.

7. The safety gate with a pet door according to claim 6, wherein the cover is provided with a plurality of locking ports; the each of the two the buttons is respectively provided with a plurality of locking members; the plurality of locking members cooperate with the plurality of locking ports to restrict the two buttons in the cover.

8. The safety gate with a pet door according to claim 2, wherein two sides of the sliding plate is respectively provided with a through hole for the two adjacent of the plurality of first connection pipes to pass through.

9. The safety gate with a pet door according to claim 1, wherein two pressure bolts are respectively arranged on the left side and the right side of the frame.

10. The safety gate with a pet door according to claim 1, wherein the one end of the first gate that locks with the frame sets as a first end; another end of the first gate that can be movably connected to the frame sets as a second end; a switch is set on a top side of the first end of the first gate; the first gate is locked with the frame or detached from the frame by the switch; a rotating shaft is arranged at the second end of the first gate; the frame is provided with a rotating hole adapted to the rotating shaft.
